(19) United States
(12) Patent Application Publication
(10) Pub. No.: US 2020/0040183 A1
(43) Pub. Date: Feb. 6, 2020

(54) THERMOPLASTIC COMPOSITIONS HAVING IMPROVED TOUGHNESS, ARTICLES THEREFROM, AND METHODS THEREOF

(71) Applicant: Braskem America, Inc., Pittsburgh, PA (US)

(72) Inventor: Rajendra K. Krishnaswamy, Pittsburgh, PA (US)

(73) Assignee: Braskem America, Inc., Pitts burgh, PA (US)

(21) Appl. No.: 16/529,578

(22) Filed: Aug. 1, 2019

Related U.S. Application Data
(60) Provisional application No. 62/713,225, filed on Aug. 1, 2018.

(51) Int. Cl. C08L 77/00; C08L 23/06; C08L 23/08; C08F 222/06; B29C 64/153; B29C 64/118

(52) U.S. Cl. CPC C08L 77/00; C08L 23/06; C08L 23/0869; B33Y 70/00; B29C 64/153; B29C 64/118; C08F 222/06

(57) ABSTRACT

A thermoplastic composition may include at least one polyamide, at least one polyethylene, and at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch, and wherein the thermoplastic composition has a bio-based carbon content of at least 50%. A thermoplastic composition may also include at least one polyamide, at least one polyethylene, and at least one compatibilizer that is a terpolymer of ethylene and two or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch.

### BACKGROUND

Rapid prototyping or rapid manufacturing processes are manufacturing processes which aim to convert available three-dimensional CAD data directly and rapidly into workpieces, as far as possible without manual intervention or use of molds. In rapid prototyping, construction of the part or assembly is usually done in an additive, layer-by-layer fashion. Those techniques that involve fabricating parts or assemblies in an additive or layer-by-layer fashion are termed “additive manufacturing” (AM), as opposed to traditional manufacturing methods which are mostly reductive in nature. Additive manufacturing is commonly referred to by the general public as “3D printing”.

There are currently several basic AM technologies: material extrusion, material jetting, binder jetting, material jetting, vat photopolymerization, sheet lamination, powder bed fusion and directed energy deposition. The most widely used of these AM technologies is based on material extrusion. While some variations exist, this technology generally involves feeding a thermoplastic polymer in the form of a continuous filament into a heated nozzle, where the thermoplastic filament becomes a viscous melt and can be therefore extruded. The 3-dimensional motion of the nozzle or the extruder assembly is precisely controlled by step motors and computer aided manufacturing (CAM) software. The first layer of the object is deposited on a build substrate, whereas additional layers are sequentially deposited and fused (or partially fused) to the previous layer by solidification due to a drop in temperature. The process continues until a 3-dimensional part is fully constructed. There are several thermoplastic polymers that are currently being used in material extrusion based AM processes. Those materials include acrylonitrile-butadiene-styrene (ABS), poly(lactic acid) (PLA), polycarbonate (PC), polystyrene (PS), high impact polystyrene (HIPS), polycaprolactone (PCL), and polyamide as well as some other polymeric materials. However, thermoplastic polyamide materials often used in additive manufacturing are not very tough.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a thermoplastic composition that includes at least one polyamide, at least one polyethylene, and at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch, and wherein the thermoplastic composition has a bio-based carbon content of at least 50%.

In one aspect, embodiments disclosed herein relate to a thermoplastic composition that includes at least one polyamide, at least one polyethylene, and at least one compatibilizer that is a terpolymer of ethylene and two or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch.

In another aspect, embodiments disclosed herein relate to a polymer powder that includes powder granules formed of a thermoplastic composition including at least one polyamide, at least one polyethylene, and at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch, and wherein the thermoplastic composition has a bio-based carbon content of at least 50%.

In another aspect, embodiments disclosed herein relate to a polymer powder that includes powder granules formed of a thermoplastic composition including at least one polyamide, at least one polyethylene, and at least one compatibilizer that is a terpolymer of ethylene and two or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch.

In yet another aspect, embodiments disclosed herein relate to a filament that includes a polymer filament formed of a thermoplastic composition including at least one polyamide, at least one polyethylene, and at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch, and wherein the thermoplastic composition has a bio-based carbon content of at least 50%.

In yet another aspect, embodiments disclosed herein relate to a filament that includes a polymer filament formed of a thermoplastic composition including at least one polyamide, at least one polyethylene, and at least one compatibilizer that is a terpolymer of ethylene and two or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch.

In another aspect, embodiments disclosed herein relate to a manufactured article that includes a thermoplastic composition including at least one polyamide, at least one polyethylene, and at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch, and wherein the thermoplastic composition has a bio-based carbon content of at least 50%.

In another aspect, embodiments disclosed herein relate to a manufactured article that includes a thermoplastic composition including at least one polyamide, at least one polyethylene, and at least one compatibilizer that is a terpolymer of ethylene and two or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch.

In yet another aspect, embodiments disclosed herein relate to a method that includes melt blending at least one polyamide, at least one polyethylene, and at least one compatibilizer that is a copolymer of ethylene and at least one comonomer selected from the group consisting of acrylic ester, glicidyl methacrylate, maleic anhydride, butyl acrylate, ethyl acrylate, and functionalized polybutadiene to form a thermoplastic composition, wherein the thermoplastic composition has a bio-based carbon content of at least 50%; and extruding the thermoplastic composition.

In yet another aspect, embodiments disclosed herein relate to a method that includes melt blending at least one polyamide, at least one polyethylene, and at least one compatibilizer that is a terpolymer of ethylene and at least two comonomers selected from the group consisting of acrylic ester, glicidyl methacrylate, maleic anhydride, butyl acrylate, ethyl acrylate, and functionalized polybutadiene to form a thermoplastic composition; and extruding the thermoplastic composition.

In yet another aspect, embodiments disclosed herein relate to a method of manufacturing a printed article (and an article formed therefrom) that includes successively printing layers of a thermoplastic composition including at least one polyamide, at least one polyethylene, and at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch, and wherein the thermoplastic composition has a bio-based carbon content of at least 50%.

In yet another aspect, embodiments disclosed herein relate to a method of manufacturing a printed article (and an article formed therefrom) that includes successively printing layers of a thermoplastic composition including at least one polyamide, at least one polyethylene, and at least one compatibilizer that is a terpolymer of ethylene and two or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch.

In yet another aspect, embodiments disclosed herein relate to a method of manufacturing a printed article (and an article formed therefrom) that includes successively printing layers of a thermoplastic composition including at least one polyamide and at least one polyethylene; and optionally, at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene.

In another aspect, embodiments disclosed herein relate to an article that includes a plurality of printed layers, at least one of which includes a thermoplastic composition including at least one polyamide, at least one polyethylene, and at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch, and wherein the thermoplastic composition has a bio-based carbon content of at least 50%.

In another aspect, embodiments disclosed herein relate to an article that includes a plurality of printed layers, at least one of which includes a thermoplastic composition including at least one polyamide, at least one polyethylene, and at least one compatibilizer that is a terpolymer of ethylene and two or more comonomers selected from the group consisting of acrylic ester, glicidyl methacrylate, maleic anhydride, butyl acrylate, ethyl acrylate and functionalized polybutadiene; wherein the thermoplastic composition has an Izod Impact energy at 0° C., as measured by ASTM D256, that is greater than 6 ft-lb./inch.

In yet another aspect, embodiments disclosed herein relate to an article that includes a plurality of printed layers, at least one of which includes a thermoplastic composition including at least one polyamide and at least one polyethylene, and optionally, at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene.

Other aspects and advantages of the claimed subject matter will be apparent from the following description and the appended claims.

### BRIEF DESCRIPTION OF DRAWINGS

FIG. 1 is graph depicting the synergistic effect achieved with polyamide/polyolefin blends with compatibilizer as compared to comparative blends.

### DETAILED DESCRIPTION

Embodiments of the present disclosure are directed to thermoplastic polymer compositions, granules or filaments thereof, articles manufactured therefrom, and methods of use thereof. In particular, embodiments disclosed herein relate to polymer compositions used in additive manufacturing, and the associated filaments or granules thereof, the articles printed therefrom, and methods of use thereof.

Additive manufacturing in accordance with the present disclosure may include layer structuring processes in which a thermoplastic is deposited in a layered fashion, such as fused deposition modeling (FDM) or selective layer sintering (SLS). While additive manufacture has utilized thermoplastics such as polylactic acid (PLA) and acrylonitrile butadiene styrene (ABS) that meet the desired qualities of melt processability, adhesion, and material strength, many commercial examples do not provide the same flexibility that other polymers may provide.

Thermoplastic polyamides are a class of materials that possess desirable properties, including excellent mechanical characteristics, high heat resistance, and good durability, that make them useful as structural materials. On the other hand, they are known to be deficient in impact resistance, notch sensitivity, and moisture resistance. To reduce these deficient properties, polyolefins may be added to the polyamide. Polyolefins such as polyethylene (PE) and polypropylene (PP) may be used to manufacture a varied range of articles, including films, molded products, foams, and the like. Polyolefins may have characteristics such as high processability, low production cost, flexibility, low density and recycling possibility. Conventionally, methods of altering the chemical nature of the polymer composition may include modifying the polymer synthesis technique or the inclusion of one or more comonomers. However, modifying the polyamide or polyolefin may also result in undesirable side effects. By way of illustration, increasing the molecular weight of a polyolefin may produce changes in the SCG and ESC, but can also increase viscosity, which may limit the processability and moldability of the polymer composition. Polymer modification by blending may vary the chemical nature of the composition, resulting in changes to the overall physical properties of the material. Material changes introduced by polymer blending may be unpredictable, however, and, depending on the nature of the polymers and additives incorporated, the resulting changes may be uneven and some material attributes may be enhanced while others exhibit notable deficits. Embodiments of the present disclosure may combine a polyamide with a polyolefin to achieve the desired properties. Due to the nature of the polar polyamide and non-polar polyolefin, it is often difficult to achieve good dispersion and thus further compatibilization of such a combination of polymers may occur. A compatibilizing agent is a material that has specific regions that can react to form bonds with each of the incompatible constituent polymers. Incompatible polymer systems that utilize these compatibilizing agents can achieve advantageous properties from the desirable characteristics of the respective polymer components.

In one aspect, embodiments disclosed herein relate to a thermoplastic polymer blend of polyamide and polyolefin having improved toughness. In another aspect, embodiments disclosed herein relate to a method for manufacturing articles comprising a compatibilized polyamide/polyolefin blend wherein the thermoplastic composition has a biobased carbon content in the range of 5 to 100%. In one or more embodiments, the thermoplastic composition may have a biobased carbon content that is at least 50, 60, 70, 80, or 90%. The use of products derived from natural sources, as opposed to those obtained from fossil sources, as raw material, has increasingly been a widely preferred alternative, as an effective means of reducing the atmospheric carbon dioxide concentration increase, therefore effectively preventing the expansion of the so called greenhouse effect. Products thus obtained from natural raw materials have a differential, relative to fossil sourced products, which is their renewable carbon contents. This renewable carbon content can be certified by the methodology described in the technical ASTM D 6866-06 Norm, “Standard Test Methods for Determining the Biobased Content of Natural Range Materials Using Radiocarbon and Isotope Ratio Mass Spectrometry Analysis”. Besides that, products obtained from renewable natural raw materials have the additional property of being able to be incinerated at the end of their life cycle, whereas only producing CO2 of a non-fossil origin. In one or more embodiments, the thermoplastic composition may exhibit a bio-based carbon content, as determined by ASTM D6866 of at least 5%. Further, other embodiments may include at least 10%, 20%, 40%, 50%, 60%, 80%, or 90% bio-based carbon. In one or more embodiments, the thermoplastic composition may comprise at least 50% or more bio-based carbon content. Such bio-based carbon may be entirely contributed by the polyamide or may also be contributed by other components as well, including the polyolefin and/or compatibilizer.

In one or more embodiments, thermoplastic compositions comprising a combination of polyamide/polyolefin and optional compatibilizer may have an IZOD impact energy at 0° C. according to ASTM D256 that is at least twice that of a neat polyamide. In one or more particular embodiments, thermoplastic compositions may have an IZOD impact energy at 0° C. according to ASTM D256 that is greater than 6 ft-lb./inch, 8 ft-lb./inch, or 11 ft-lb./inch.

Conventional polymers used in additive manufacturing include, for example, PLA and ABS or polyamide. Polyolefins, on the other hand, are generally not used in additive manufacturing because the articles, as each successive layer is deposited and cools, exhibit shrinkage, warpage, and/or curling (at the edges and corners), for example. However, embodiments of the present disclosure are directed to polyolefin containing compositions that exhibit reduced physical distortion during additive manufacturing than conventional polyolefins.

Polyamide

At present, the most commonly used polymer materials on the market are acrylonitrile-butadiene-styrene (ABS) copolymer, polylactic acid (PLA), polyamide and polycarbonate (PC), wherein polyamide is the most widely used printing raw materials. Among polyamide materials, only nylon 12 is currently the major material for 3D printing, mainly because nylon 12 has the lowest melting temperature, less water absorption and molding shrinkage, which is the most suitable material for powder sintering, but the cost is high. In addition, when the pure nylon powder material is used for the 3D printing process, the prepared products may not have good dimensional stability and heat resistance.

The thermoplastic polymer compositions in accordance with the present disclosure may include one or more polyamide polymers that are combined with a polyolefin and, further, may be optionally compatibilized by one or more compatibilizing agents. In one or more embodiments the thermoplastic composition may comprise a polyamide selected from at least one of nylon 6, nylon 6,6, nylon 6,9, nylon 6,10, nylon 6,12, nylon 4,6, nylon 11, nylon 12 and nylon 12,12, for example. The polyamide may be present in the thermoplastic composition in an amount ranging from 60 to 99.4 wt % of the thermoplastic composition, including lower limits of any of 60, 65, 70, 75, 80, or 85 wt % and upper limits of any of 80, 85, 90, 95, 99, 99.25, or 99.4 wt %, where any lower limit can be used in combination with any upper limit.

Thermoplastic compositions in accordance may incorporate one or more polyamides. In some embodiments, the polyamide can be derived from fossil sources, while in other embodiments, the polyamide can be derived from renewable sources such as bio-based polyamide that is obtained from castor beans or castor oil. For example, castor oil may be hydrolyzed to result in ricinoleic acid, which may be used to eventually produce, for example, 11-aminoundecanoic acid (used to make polyamide 11), sebacic acid (used with diamines to form, for example PA 410, PA 510, PA610, PA1010). In one or more embodiments, the polyamide may exhibit a bio-based carbon content, as determined by ASTM D6866 of at least 5%. Further, other embodiments the polyamide may include at least 10%, 20%, 40%, 50%, 60%, 80%, or 90% bio-based carbon.

Polyolefin

Thermoplastic compositions in accordance with the present disclosure may include at least one polyolefin. In one or more embodiments, polyolefins include polymers produced from unsaturated monomers (olefins or “alkenes”) with the general chemical formula of CₙH₂ₙ. In some embodiments, polyolefins may include ethylene homopolymers, copolymers of ethylene and one or more C3-C20 alpha-olefins, propylene homopolymers, heterophasic propylene polymers, copolymers of propylene and one or more comonomers selected from ethylene and C3-C20 alpha-olefins, olefin terpolymers and higher order polymers, and blends obtained from the mixture of one or more of these polymers and/or copolymers. In some embodiments, polyolefins may be generated with a suitable catalyst such as Ziegler, metallocene, and chromium catalysts. In one or more embodiments, the amount of polyolefin present may range from a lower limit of any 0.5, 1, 2, 3, 5, or 10 wt %, and an upper limit from any of 15, 18, 20, 25, 28, or 30 wt %, where any lower limit can be used in combination with any upper limit.

More specifically, in one or more embodiments, the thermoplastic composition may comprise at least one polyethylene that is selected from the group consisting of polyethylene homopolymer, copolymers of ethylene and one or more C3-C20 alpha-olefins, ethylene vinyl acetate, ethylene vinyl alcohol, ethylene alkyl acrylates (such as butyl acrylate) optionally grafted with maleic anhydride, polyethylene based ionomers, high density polyethylene, medium density polyethylene, low density polyethylene, linear low density polyethylene, very low density polyethylene, ultra low density polyethylene, ultrahigh molecular weight polyethylene.

Polyethylenes particularly employed in the practice of the present compositions include those known in the art as linear low-density polyethylene (LLDPE).

In one or more embodiments, the thermoplastic composition may comprise a polyolefin, including but not limited to a polyethylene such as LLDPE, in a range from 2 to 30 wt %. For example, lower limits may include any of 2, 4, 5, or 10 wt %, and upper limits may include any of 10, 15, 20, 25, or 30 wt %, where any lower limit can be used in combination with any upper limit.

In one or more embodiments, polyethylene may include polyethylene generated from petroleum based monomers and/or biobased monomers, such as ethylene obtained by the dehydration of biobased alcohols obtained from sugarcane. Commercial examples of biobased polyethylenes are the “I'm Green”™ line of bio-polyethylenes from Braskem S.A.

For example, in one or more embodiments, the renewable source of carbon is one or more plant materials selected from the group consisting of sugar cane and sugar beet, maple, date palm, sugar palm, sorghum, American agave, corn, wheat, barley, sorghum, rice, potato, cassava, sweet potato, algae, fruit, materials comprising cellulose, wine, materials comprising hemicelluloses, materials comprising lignin, wood, straw, sugarcane bagasse, sugarcane leaves, corn stover, wood residues, paper, and combinations thereof.

In one or more embodiments, the bio-based ethylene may be obtained by fermenting a renewable source of carbon to produce ethanol, which may be subsequently dehydrated to produce ethylene. Further, it is also understood that the fermenting produces, in addition to the ethanol, byproducts of higher alcohols. If the higher alcohol byproducts are present during the dehydration, then higher alkene impurities may be formed alongside the ethanol. Thus, in one or more embodiments, the ethanol may be purified prior to dehydration to remove the higher alcohol byproducts while in other embodiments, the ethylene may be purified to remove the higher alkene impurities after dehydration.

Thus, biologically sourced ethanol, known as bio-ethanol, is obtained by the fermentation of sugars derived from cultures such as that of sugar cane and beets, or from hydrolyzed starch, which is, in turn, associated with other cultures such as corn. It is also envisioned that the bio-based ethylene may be obtained from hydrolysis based products from cellulose and hemi-cellulose, which can be found in many agricultural by-products, such as straw and sugar cane husks. This fermentation is carried out in the presence of varied microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina. Other examples include the teachings described in U.S. Pat. Nos. 9,181,143 and 4,396,789, which are herein incorporated by reference in their entirety.

In one or more embodiments, the polyolefin may exhibit a bio-based carbon content, as determined by ASTM D6866 of at least 5%. Further, other embodiments the polyolefin may include at least 10%, 20%, 40%, 50%, 60%, 80%, or 90% bio-based carbon.

Compatibilizing Agent

As noted above, it is often difficult to achieve successful mixtures and efficient dispersion of polar and non-polar polymers, such as polyamide and polyolefin. In some embodiments, compatibilizing agents may be optionally added to modify the interactions between the polyolefin and the polar polymer. As found by the present inventors, the incorporation of a compatibilizing agent may advantageously improve the impact strength of engineered thermoplastics.

In one or more embodiments, the compatibilizer of the thermoplastic composition may be a copolymer of ethylene and one or more comonomers selected from the group consisting of acrylic ester, glycidyl methacrylate, maleic anhydride, butyl acrylate, ethyl acrylate, and functionalized polybutadiene. In particular embodiments, the compatibilizer of the thermoplastic composition may be a copolymer of ethylene and at least comonomer that may include either maleic anhydride or butyl acrylate, such as a maleic anhydride grafted polyethylene or a copolymer of ethylene and butyl acrylate.

In one or more embodiments, the compatibilizer of the thermoplastic composition may be a terpolymer of ethylene and at least two comonomers selected from the group consisting of acrylic ester, glycidyl methacrylate, maleic anhydride, butyl acrylate, ethyl acrylate, and functionalized polybutadiene. In another embodiment, the compatibilizer of the thermoplastic composition may be a terpolymer of ethylene and two comonomers that are acrylic ester and glycidyl methacrylate.

In one or more embodiments, the thermoplastic composition may comprise a compatibilizing agent in an amount so that the thermoplastic composition exhibits a no-break impact behavior. For example, the compatibilizer may be present in an amount ranging from 0.1 to 10 wt % of the thermoplastic composition, or amounts having a lower limit of any of 0.1, 0.5, 1, 2, 3, or 5 wt % and an upper limit of any of 5, 7, 8, 9, or 10 wt %, where any lower limit can be combined with any upper limit. In another embodiment, the thermoplastic composition may comprise a compatibilizer in a range from 0.5 to 5.0 wt % of the thermoplastic composition. Additionally, in accordance with one or more embodiments, the compatibilizer may be partially or totally obtained from renewable resources.

Additives

As mentioned, a number of additives may be incorporated into thermoplastic compositions in accordance with the present disclosure that may include for example, stabilizers, antioxidants (for example hindered phenols such as Irganox™ 1010 from the BASF Corporation), phosphites (for example Irgafos™ 168 from the BASF Corporation), cling additives (for example polyisobutylene), polymeric processing aids (such as Dynamar™5911 from 3M Corporation or Silquest™ PA-1 from Momentive Performance Materials), fillers, colorants, clarifiers (for example, Millad 3988i and Millad NX8000 from Milliken & Co.); antiblock agents, acid scavengers, waxes, antimicrobials, UV stabilizers, nucleating agents (for example talc, sodium benzoate, Sodium 2,2′-methylene bis-(4,6-di-tert-butyl phenyl)phosphate, 2,2′-Methylenebis-(2,6-ditert-butylphenyl)phosphate (lithium salt), Aluminum hydroxybis [2,4,8,10-tetrakis(1,1-dimethylethyl)-6-hydroxy-12-H-dibenzo [d,g][1,3,2]dioxaphosphocin 6-oxidato], dibenzilidene sorbitol, nonitol 1,2,3-trideoxy-4,6:5,7-bis-O-[(4-propylphenyl)methylene], Cis-endo-bicyclo [2.2.1]heptane-2,3-dicarboxylic acid (disodium salt), 1R,2S-cyclohexanedicarboxylic acid (calcium salt), zinc stearate, pigments that act as nucleators, aromatic carboxylic acids, calcium carbonate, pimelic acid, calcium hydroxide, stearic acid, organic phosphates, and mixtures thereof), optical brighteners, long term heat agents, slip agents, pigments, processing aids, antistatic agents, polyethylene, impact modifiers, compatibilizers, as well as any combinations of the aforementioned additives. Such additives may be added to the extruder to prepare the compositions having specific properties.

Extrusion Process

In one or more embodiments, thermoplastic compositions in accordance with the present disclosure may be prepared=by melt blending. Methods may use single-, twin- or multi-screw extruders, which may be used at temperatures ranging from 100° C. to 270° C. in some embodiments, and from 140° C. to 230° C. in some embodiments. In some embodiments, raw materials are added to an extruder, simultaneously or sequentially, into the main or secondary feeder in the form of powder, granules, flakes or dispersion in liquids as solutions, emulsions and suspensions of one or more components. The components can be pre-dispersed in prior processes using intensive mixers, for example. In some embodiments, the melt blending process of above may be used to form a polymer powder comprising power granules formed of the thermoplastic composition as described in the preceding embodiments. Yet in other embodiments, the melt blending process of above may be used to form a filament comprising polymer filament formed of the thermoplastic composition as described in the preceding embodiments.

Articles

The formed thermoplastic composition may then be used to form one or more manufactured articles, including but not limited to an injection molded article, a thermoformed article, a film, a foam, a blow molded article, a rotomolded article, a extruded article, a pultruded article, or a printed article.

In particular, thermoplastic compositions of the present disclosure may be applicable for use in various additive manufacturing processes. Additive manufacturing systems in accordance with the present disclosure, include any system that prints, builds, or otherwise produces 3D parts and/or support structures. Additive manufacturing systems may be a stand-alone unit, a sub-unit of a larger system or production line, and/or may include other non-additive manufacturing features, such as subtractive-manufacturing features, pick-and-place features, two-dimensional printing features, and the like.

Thermoplastic polymer compositions may be formulated in some embodiments as an extruded filament or granule (or pellet) which may be used in an additive manufacturing process. Filament may have a diameter, for example, of 1.0 to 4.0 mm, including for example filaments having a diameter ranging from 1.5 to 3 mm, such as a diameter of 1.75 mm or 2.85 mm, for example. Pellets may have a similar diameter.

Generally, examples of commercially available additive manufacturing techniques include extrusion-based techniques such as fused filament fabrication (FFF), fused deposition modeling (FDM) or freeforming, electro-photography (EP), jetting, selective laser sintering (SLS), high speed sintering (HSS), powder/binder jetting, electron-beam melting, and stereolithographic processes. For each of these techniques, the digital representation of the 3D part is initially sliced into multiple horizontal layers. For each sliced layer, a tool path is then generated, which provides instructions for the particular additive manufacturing system to print the given layer. Particular additive manufacturing techniques that may be particularly suitable for the present polymer compositions include, for example, fused deposition modeling, selective laser sintering, high speed sintering, material jetting, or plastic free forming.

While additive manufacture has utilized thermoplastics such as polyamide materials that meet the desired qualities of melt process-ability, and adhesion, many commercial examples do not provide the same flexibility and toughness that polypropylene or other polymers may provide.

For example, in an extrusion-based additive manufacturing system, a 3D part may be printed from a digital representation of the 3D part in a layer-by-layer manner by extruding a molten flowable part material. The part material is extruded through an extrusion tip carried by a print head of the system, and is deposited as a sequence of roads on a substrate in an x-y plane. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation.

For example, according to fused deposition modeling, a filament or granules formed from the thermoplastic polymer composition discussed above are heated and extruded through an extrusion head that deposits the molten plastic in X and Y coordinates, while the build table lowers the object layer by layer in the Z direction.

Selective laser sintering uses powdered material in the build area instead of liquid or molten resin. A laser is used to selectively sinter a layer of granules, which binds the material together to create a solid structure. When the object is fully formed, it is left to cool in the machine before being removed. In high speed sintering (HSS), manufacturing occurs by depositing a fine layer of polymeric powder, after which inkjet printheads deposit an infrared (IR) absorbing fluid (or toner powder) directly onto the powder surface where sintering is desired. The entire build area is then irradiated with an IR radiation source such as an infrared lamp, causing the printed fluid to absorb this energy and then melt and sinter the underlying powder. This process is then repeated layer by layer until the build is complete. While SLS and HSS are detailed as examples of powder bed fusion techniques, it is also envisioned that the thermoplastic compositions may be adapted for use in other powder bed fusion techniques such as selective heat sintering (SHS), selective laser melting (SLM), selective absorbing sintering (SAS), and selective inhibition sintering (SIS).

Further, it is also understood that while an article of the present disclosure may be formed using an “additive manufacturing system”, such “additive manufacturing system” refers to a system that prints, builds, or otherwise produces 3D parts and/or support structures at least in part using an additive manufacturing technique. The additive manufacturing system may be a stand-alone unit, a sub-unit of a larger system or production line, and/or may include other non-additive manufacturing features, such as subtractive-manufacturing features, pick-and-place features, two-dimensional printing features, and the like.

Further, the use of the present polymer compositions, rather than conventional polymers used in additive manufacturing, may provide greater flexibility in the products produced by the additive manufacturing methods. Specifically, for example, the articles produced by additive manufacturing may have significantly improved toughness excellent fatigue resistance as compared to polyamide, for example. Additionally, the articles produced by additive manufacturing may be produced without compromising the biobased carbon component of the base material.

Specific articles that may be formed include, for example, packaging, rigid and flexible containers, household appliances, molded articles such as caps, bottles, cups, pouches, labels, pipes, tanks, drums, water tanks, medical devices, shelving units, and the like. Specifically, any article conventionally made from the polymer compositions of the present disclosure (using conventional manufacturing techniques) may instead be manufactured from additive manufacturing. In one or more embodiments, the article formed may comprise a plurality of printed layers where at least one of which comprises the thermoplastic composition as described in the preceding embodiments.

### EXAMPLES

In the following examples, a number of composition samples are analyzed to demonstrate the changes in physical and chemical properties associated with thermoplastic compositions prepared in accordance with the present disclosure.

The sample compositions of all examples were prepared via a melt blending process as described herein. The melt blending was accomplished using an 18 mm Coperion co-rotating twin-screw extruder using the following temp profile 240/240/240/230/230/220/210/200 (° C.) at a rate of 10 lbs/hr and a screw speed of 300 rpm. The subject pellet mixes were tumble-blended prior to their introduction into the feed throat of the Coperion extruder.

### Example 1

The composition components and test results of the samples of Example 1 are shown in Table 1 below:

TABLE 1

| | Blend Ingredient | | | | | |
|---|---|---|---|---|---|---|
| | | | | | | 6 |
| | 1 | 2 | 3 | 4 | 5 | Neat |
| | Neat PA | Control | Control | Inventive | Inventive | LLDPE |
| | control | Blend-1 | Blend-2 | Blend-1 | Blend-2 | control |
| Polyamide | 100 | 85 | 70 | 81 | 67 | 0 |
| LLDPE | 0 | 15 | 30 | 14 | 28 | 100 |
| Compatibilizer | 0 | 0 | 0 | 5 | 5 | 0 |
| Total (wt %) | 100 | 100 | 100 | 100 | 100 | 100 |
| Izod Impact @ 0 C. | 1.9 | 5.9 | 6 | 16.4 | 11.8 | 7.4 |
| [ft-lb./inch] | | | | | | |
| Izod - Specimen | Complete | Partial | Non- | Non- | Non- | Non- |
| Condition on Impact | Break | Break | Break | Break | Break | Break |
| Tangent Modulus | 185504 | 161132 | 133213 | 136229 | 113494 | 17513 |
| (psi) | | | | | | |

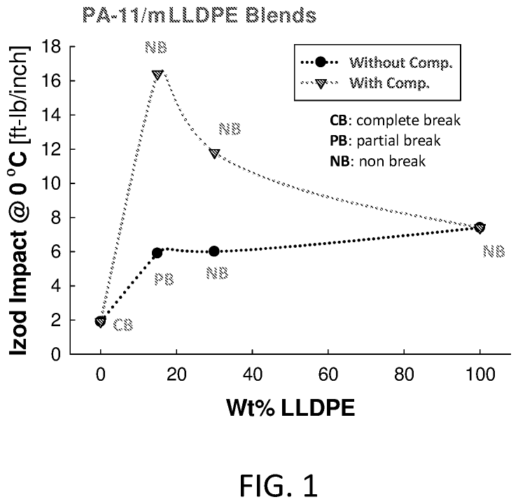

As demonstrated in the table above and further confirmed in FIG. 1, at low loading levels, around 15%, LLDPE, the compatibilized blends show significantly higher impact toughness compared to either of the pure components, polyamide or LLDPE. This notable synergistic effect is a significant result as it provides an avenue to increase the impact toughness without compromising the processing attributes of the polyamide material required for 3D printing and without compromising the biobased carbon content of the polyamide.

### Example 2

The composition components and test results of the samples of Example 2 are shown in Table 2 below. In this example, Sample 7 is the control, and Samples 8 and 9 are the inventive samples containing blends of polyamide with a Green LDPE, with Sample 9 containing the compatibilizer.

Samples 8 and 9 display significantly higher Izod impact strength at 0° C. and at −20° C. compared to the neat polyamide control. Sample 8 displays only a slightly lower modulus compared to the control; the modulus of the compatibilized Sample 9 is lower. While the break strength of Sample 8 is lower than that of the control, the break strength of Sample 9 is much higher than that of the control. The elongation to break is greatly enhanced for both blends. Compared to the neat polyamide, the two blend samples with a Green LDPE demonstrate significantly tougher materials without any compromise to the biobased carbon content of the polyamide.

### Example 3

The composition components and test results of the samples of Example 3 are shown in Table 2 below. In this example, Sample 7 is the control, and Samples 10 and 11 are the inventive samples containing blends of polyamide with a Green HDPE, with Sample 11 containing the compatibilizer. Samples 10 and 11 display significantly higher Izod impact strength at 0° C. and at −20° C. compared to the neat polyamide control. Sample 10 displays higher modulus compared to the control—this is an example where the blend displays higher modulus AND impact toughness compared to neat polyamide; the modulus of the compatibilized Sample 10 is, however, lower. While the break strength of Sample 10 is lower than that of the control, the break strength of Sample 11 is higher than that of the control. The elongation to break is greatly enhanced for both blends. Compared to neat polyamide, the two blend examples with Green HDPE demonstrate significantly tougher materials without any compromise to the biobased carbon content of the polyamide.

### Example 4

The composition components and test results of the samples of Example 4 are shown in Table 2 below. In this example, Sample 7 is the control, and Samples 12 and 13 are the inventive samples containing blends of polyamide with a Green HDPE, with Sample 13 containing the compatibilizer. Samples 12 and 13 display significantly higher Izod impact strength at 0° C. and at −20° C. compared to neat polyamide. Sample 12 displays similar modulus compared to the control; the modulus of the compatibilized Sample 13 is lower. The break strength of Sample 12 and 13 are significantly higher than that of the control. The elongation to break is also greatly enhanced for both blends. Compared to neat polyamide, the two blend examples with a Green HDPE demonstrate significantly tougher materials without any compromise to the biobased carbon content of the polyamide; the modulus is also not affected.

### Example 5

The composition components and test results of the samples of Example 5 are shown in Table 2 below. In this example, Sample 7 is the control, and Samples 14 and 15 are the inventive samples containing blends of polyamide with an LLDPE, with Sample 15 containing the compatibilizer. Samples 14 and 15 display significantly higher Izod impact strength at 0° C. and at −20° C. compared to neat polyamide. Samples 14 and 15 display lower modulus compared to the control. The break strength of Sample 14 and 15 are significantly higher than that of the control. The elongation to break is also greatly enhanced for both blends. Compared to neat polyamide, the two blend examples with LLDPE demonstrate significantly tougher materials with only a small compromise in modulus.

### Example 6

The composition components and test results of the samples of Example 6 are shown in Table 2 below. In this example, Sample 7 is the control, and Samples 16 and 17 are the inventive samples containing blends of polyamide with an ethylene-butyl acrylate (EBA) copolymer, with Sample 17 containing the compatibilizer. Samples 16 and 17 display significantly higher Izod impact strength at 0° C. and at −20° C. compared to neat polyamide. Samples 16 and 17 display lower modulus compared to the control. The break strength of Sample 16 and 17 are significantly higher than that of the control. The elongation to break is also greatly enhanced for both blends. Compared to neat polyamide, the two blend examples with EBA (a polyethylene copolymer having polar functionality) demonstrate significantly tougher materials with only a small compromise in modulus.

### Example 7

The composition components and test results of the samples of Example 7 are shown in Table 2 below. In this example, Sample 7 is the control, and Samples 18 and 19 are the inventive samples containing blends of polyamide with an ethylene-butyl acrylate (EBA) copolymer with maleic anhydride (MA) grafted onto the backbone, with Sample 19 containing the compatibilizer. Samples 18 and 19 display significantly higher Izod impact strength at 0° C. and at −20° C. compared to neat polyamide, with none of the Sample 19 Izod specimens even breaking during the test. Samples 18 and 19 display lower modulus compared to the control. The break strength of Sample 18 and 19 are significantly higher than that of the control. The elongation to break is also greatly enhanced for both blends. Compared to neat polyamide, the two blend examples with EBA-grafted MA (a polyethylene copolymer having polar functionality) demonstrate significantly tougher materials with only a small compromise in modulus.

TABLE 2

| Blend Ingredient | 7 | 8 | 9 | 10 | 11 | 12 | 13 | 14 | 15 | 16 | 17 | 18 | 19 |
|---|---|---|---|---|---|---|---|---|---|---|---|---|---|
| Polyamide | 100 | 85 | 81 | 85 | 81 | 85 | 81 | 85 | 81 | 85 | 81 | 85 | 81 |
| Green LDPE (MI | 0 | 15 | 15 | 0 | 0 | 0 | 0 | 0 | 0 | 0 | 0 | 0 | 0 |
| ~22) | | | | | | | | | | | | | |
| Green HDPE (MI | 0 | 0 | 0 | 15 | 15 | 0 | 0 | 0 | 0 | 0 | 0 | 0 | 0 |
| ~20) | | | | | | | | | | | | | |
| Green HDPE (MI | 0 | 0 | 0 | 0 | 0 | 15 | 15 | 0 | 0 | 0 | 0 | 0 | 0 |
| ~0.7) | | | | | | | | | | | | | |
| LLDPE | 0 | 0 | 0 | 0 | 0 | 0 | 0 | 15 | 15 | 0 | 0 | 0 | 0 |
| EBA | 0 | 0 | 0 | 0 | 0 | 0 | 0 | 0 | 0 | 15 | 15 | 0 | 0 |
| EBA-grafted MA | 0 | 0 | 0 | 0 | 0 | 0 | 0 | 0 | 0 | 0 | 0 | 15 | 15 |
| Compatibilizer | 0 | 0 | 4 | 0 | 4 | 0 | 4 | 0 | 4 | 0 | 4 | 0 | 4 |
| Total Wt % | 100 | 100 | 100 | 100 | 100 | 100 | 100 | 100 | 100 | 100 | 100 | 100 | 100 |
| Izod Impact @0° C. | 0.9 | 3.0 | 2.1 | 3.4 | 2.5 | 2.3 | 2.1 | 2.7 | 2.5 | 4.6 | 3.7 | 2.5 | 4.5 |
| [ft-lb./inch] | | | | | | | | | | | | | |
| Izod - Specimen | CB | PB | PB | PB | CB | PB | PB | PB | PB | PB | CB | P&C | NB |
| Condition on Impact | | | | | | | | | | | | | |
| Izod Impact @20° C. | 0.4 | 3.2 | 1.7 | 2.9 | 2.0 | 1.9 | 1.7 | 1.9 | 1.9 | 3.3 | 2.5 | 2.1 | 2.5 |
| [ft-lb./inch] | | | | | | | | | | | | | |
| Izod - Specimen | CB | PB | CB | PB | CB | CB | P&C | P&C | CB | PB | CB | CB | CB |
| Condition on Impact | | | | | | | | | | | | | |
| Tensile Modulus | 186 | 161 | 136 | 193 | 155 | 178 | 158 | 163 | 141 | 158 | 135 | 150 | 134 |
| (kpsi) | | | | | | | | | | | | | |
| Tensile Break Stress | 3954 | 2597 | 5919 | 1015 | 6130 | 7039 | 6400 | 6411 | 5838 | 6368 | 5640 | 6410 | 6123 |
| (psi) | | | | | | | | | | | | | |
| Tensile Break Strain | 46 | 89 | 322 | 165 | 343 | 326 | 339 | 355 | 334 | 354 | 329 | 289 | 291 |
| (%) | | | | | | | | | | | | | |
| Tensile Yield Stress | 5701 | 4952 | 4581 | 5442 | 4884 | 5246 | 4907 | 5043 | 4552 | 4902 | 4426 | 4769 | 4459 |
| (psi) | | | | | | | | | | | | | |

CB is Complete Break
PB is Partial Break
P&C is Partial and Complete Break
NB is No Break

In sum, as demonstrated in the above examples, by blending a polyethylene with the polyamide, the modulus and impact toughness can be increased simultaneously, and the break strength and elongation to break can also increase considerably.

Although the preceding description is described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A thermoplastic composition comprising:
at least one polyamide;
at least one polyethylene; and
at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene;
wherein the thermoplastic composition has an Izod Impact energy at 0° C., as measured by ASTM D256, that is greater than 6 ft-lb./inch, and
wherein the thermoplastic composition has a bio-based carbon content of at least 50%.

2. The thermoplastic composition of claim 1, wherein the at least one compatibilizer is a copolymer of ethylene and butyl acrylate.

3. The thermoplastic composition of claim 1, wherein the at least one compatibilizer is a maleic anhydride-grafted polyethylene.

4. A thermoplastic composition comprising:
at least one polyamide,
at least one polyethylene, and
at least one compatibilizer that is a terpolymer of ethylene and at least two comonomers selected from the group consisting of acrylic ester, glicidyl methacrylate, maleic anhydride, butyl acrylate, ethyl acrylate and functionalized polybutadiene; and
wherein the thermoplastic composition has an Izod Impact energy at 0° C., as measured by ASTM D256, that is greater than 6 ft-lb./inch.

5. The thermoplastic composition of claim 4, wherein the at least one compatibilizer is a terpolymer of ethylene, acrylic ester and glycidyl methacrylate.

6. The thermoplastic composition of claim 4, wherein the thermoplastic composition has a biobased carbon content in the range of 5 to 100%.

7. The thermoplastic composition of claim 4, wherein the thermoplastic composition exhibits a no-break impact behavior as measured by ASTM D256.

8. The thermoplastic composition of claim 4, wherein the at least one polyethylene is present in a range of 2 to 30 wt. % of the thermoplastic composition.

9. The thermoplastic composition of claim 4, wherein the at least one compatibilizer is present in a range of 0.5 to 5.0 wt. % of the thermoplastic composition.

10. The thermoplastic composition of claim 4, wherein the at least one polyamide is selected from the group consisting of nylon 6, nylon 6,6, nylon 6,9, nylon 6,10, nylon 6,12, nylon 4,6, nylon 11, nylon 12 and nylon 12,12.

11. The thermoplastic composition of claim 4, wherein the at least one polyethylene is selected from the group consisting of polyethylene homopolymer, copolymers of ethylene and one or more C3-C20 alpha-olefins, ethylene vinyl acetate, ethylene vinyl alcohol, polyethylene based ionomers, high density polyethylene, medium density polyethylene, low density polyethylene, linear low density polyethylene, very low density polyethylene, ultra low density polyethylene, ultrahigh molecular weight polyethylene.

12. The thermoplastic composition of claim 11, wherein the at least one polyethylene is a linear low density polyethylene.

13. The thermoplastic composition of claim 4, wherein the at least one polyamide is partially or totally obtained from renewable bio-based carbon sources.

14. The thermoplastic composition of claim 4, wherein the polyethylene is partially or totally obtained from renewable bio-based sources.

15. The thermoplastic composition of claim 4, wherein the at least one compatibilizer is partially or totally obtained from renewable bio-based sources.

16. The thermoplastic composition of claim 4, wherein the composition is prepared by melt blending process.

17. A polymer powder comprising powder granules formed of the thermoplastic composition of claim 1.

18. A filament comprising a polymer filament formed of the thermoplastic composition of claim 1.

19. A manufactured article comprising the thermoplastic composition of claim 1.

20. The manufactured article of claim 19, wherein the article is an injection molded article, a thermoformed article, a film, a foam, a blow molded article, a rotomolded article, an extruded article, a pultruded article, or a printed article.

21. A manufactured article comprising the thermoplastic composition of claim 4.

22. The manufactured article of claim 21, wherein the article is an injection molded article, a thermoformed article, a film, a foam, a blow molded article, a rotomolded article, an extruded article, a pultruded article, or a printed article.

23. A method, comprising:
melt blending at least one polyamide, at least one polyethylene, and at least one compatibilizer that is a terpolymer of ethylene and at least two comonomers selected from the group consisting of acrylic ester, glicidyl methacrylate, maleic anhydride, butyl acrylate, ethyl acrylate, and functionalized polybutadiene to form the thermoplastic composition of any of the above claims; and
extruding the thermoplastic composition.

24. The method of claim 23, wherein the extruded thermoplastic composition is a polymer powder.

25. The method of claim 24, wherein the extruded thermoplastic composition is a polymer filament.

26. A method, comprising:
melt blending at least one polyamide, at least one polyethylene, and at least one compatibilizer that is a terpolymer of ethylene and at least one comonomer selected from the group consisting of acrylic ester, glicidyl methacrylate, maleic anhydride, butyl acrylate, ethyl acrylate, and functionalized polybutadiene to form the thermoplastic composition of any of the above claims, wherein the thermoplastic composition has a bio-based carbon content of at least 50%; and
extruding the thermoplastic composition.

27. The method of claim 26, wherein the extruded thermoplastic composition is a polymer powder.

28. The method of claim 27, wherein the extruded thermoplastic composition is a polymer filament.

29. A method of manufacturing a printed article, comprising:
successively printing layers of the thermoplastic composition of claim 1.

30. A method of manufacturing a printed article, comprising:
successively printing layers of the thermoplastic composition of claim 4.

31. A method of manufacturing a printed article, comprising
successively printing layers of a thermoplastic composition that comprises:
at least one polyamide;
at least one polyethylene; and

32. The method of claim 31, wherein the thermoplastic composition further comprises at least one compatibilizer that is a copolymer of ethylene and one or more comonomers selected from the group consisting of acrylic ester, glicidyl methacrylate, maleic anhydride, butyl acrylate, ethyl acrylate, and functionalized polybutadiene.

33. The method of claim 31, wherein the successive printing comprises:
depositing a layer of powder comprising the thermoplastic composition on a target surface; and
melting and sintering the thermoplastic composition.

34. The method of claim 31, wherein the successive printing comprises:
successively depositing layers of a molten polymer phase, the molten polymer phase comprising the thermoplastic composition.

35. The method of claim 34, wherein the method further comprises: melting a polymer filament comprising the thermoplastic composition to form the molten polymer phase.

36. An article formed by the method of claim 31.

37. An article, comprising:
a plurality of printed layers, at least one of which comprises the thermoplastic composition of claim 1.

38. An article, comprising:
a plurality of printed layers, at least one of which comprises a thermoplastic composition that comprises:
at least one polyamide; and
at least one polyethylene.

39. The article of claim 38, wherein the thermoplastic composition further comprises at least one compatibilizer that is a copolymer of ethylene and one or more comonomers selected from the group consisting of acrylic ester, glicidyl methacrylate, maleic anhydride, butyl acrylate, ethyl acrylate and functionalized polybutadiene.
